(19) United States
(12) Patent Application Publication
(10) Pub. No.: US 2007/0233815 A1
(43) Pub. Date: Oct. 4, 2007

(54) Initialization picture displaying method

(75) Inventors: Ying-Chih Lu, Taipei (TW); Ling-Hung Yu, Taipei (TW); Chia-Hsing Lee, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,845

(22) Filed: Mar. 30, 2006

(51) Int. Cl. G06F 15/16

(52) U.S. Cl. 709/219

(57) ABSTRACT

An initialization picture displaying method is applicable to a server such as a network-attached storage (NAS) server without a display chip for remotely displaying working messages of the server. The initialization picture displaying method includes (1) utilizing a chipset to reserve a region of a memory as a display chip buffer, (2) initializing an option ROM completely, and (3) after the option ROM is initialized completely releasing the reserved region of the memory. Therefore, even if the server does not have any display chip, the NAS sever can still correctly remotely display an initialization picture of an option ROM.

### BACKGROUND OF THE INVENTION

1. Field of the Invention

The present invention relates to message outputting techniques and, more particularly, to an initialization picture displaying method capable of correctly remotely displaying an initialization picture of an option ROM when a network-attached storage server is executing a serial console even if the network-attached storage server is not provided with a display chip.

2. Description of Related Arts

Network structures are generally categorized into three groups: direct-attached storage (DAS), network-attached storage (NAS), and storage area networks (SAN). Of the three groups, DAS is the most efficient. However, DAS does not provide resource-sharing functionality. That is, only a server is allowed to access a DAS, and the DAS is considered to be lacking in expandability. Moreover, the information technology budget of an enterprise is greatly burdened by the high cost of a fiber switch and the restriction in distance and layout of a fiber network. The other two groups, SAN and NAS, come to the market to solve the problems. NAS is generally applied to a storage system without mission critical applications.

A storage structure is becoming one of the most dominant items in information technology construction. In the 80's, 90's and beyond, server hosts, networks, and data dominate the information technology structure. The amount of data in the 80's was still small, so the information technology put its emphasis on how to increase the operating speed of the central processing unit (CPU). That is why CPU manufactures often state how many clock cycles have been gained when they proposes a new CPU model. However, the information technology field no longer focuses on clock speed, but on how to store a large amount of data. Therefore, data storage devices are becoming one of the most important information technology components in an enterprise. In the 21^{st} century, a variety of data storage devices, each of which has astonishing data storage capabilities, has come to the market to satisfy all kinds of demands. The data storage industry has also realigned. For example, Symantec merged with Veritas; Sun merged with StorageTek and Procom; NetApp merged with Decru; and EMC merged with Dantz, LEGATTO, Documentum and Vmware. These mergers can be categorized into a variety of groups. For example, a first group being a server manufacturer merger with a data storage manufacturer, and a second group being an information security manufacturer merged with a data storage manufacturer. However, the data storage manufacture is always present in the merged group and that is why it is becoming more and more dominant in the market.

NAS is one kind of storage technique and is proposed by Network Application Co. NAS storage techniques allow a plurality of users on different computer platforms to access data files via a professional server. NAS, if installed on Ethernet, adopts a professional server to manage information flow on a local network on the basis of Internet Protocol, and provides a data storage protocol common to a plurality of servers and work stations. Because the server is installed specifically for accessing data, other servers can therefore dedicate themselves to executing instructions. One of the most important characteristics of this technique is that it can allocate a plurality of storage spaces in different servers or work stations. However, in that a NAS server functions as a server, the NAS server is usually located in a server room, so that an administrator of the NAS server does not have to keep surveillance on the NAS server all the time. Therefore, the main board of the NAS server is not generally provided with a display chip, and the NAS server is unable to provide any display chip buffer for a serial console. Rather than having a local display in the server room, typically, a program operated on a remote computer in a control room generates a display representing the state of the server located in the server room. But such programs don't always perfectly represent the state of the server, particularly when a low-level program such as an option ROM program has accessed the display chip buffer. As a result, an erroneous initialization picture is remotely displayed if an option ROM accesses the display chip buffer directly. It is therefore greatly desirable in the art to enable an option ROM, without any amendment, to correctly remotely display an initialization picture of the option ROM when executing a serial console.

### SUMMARY OF THE INVENTION

In view of the above-mentioned problem of the prior art, it is a primary objective of the present invention to provide an initialization picture displaying method by utilizing a basic input/output system (BIOS) to provide a buffer. Therefore, option ROM manufacturers can still remotely display the initialization picture of an option ROM correctly, without performing an amendment process when executing a serial console.

The initialization picture displaying method includes (1) utilizing a chipset to reserve a region of a memory as a display chip buffer, (2) initializing an option ROM completely, and (3) after the option ROM is initialized completely releasing the reserved region of the memory.

In summary, the initialization picture displaying method provided by the present invention is applicable to a network-attached storage (NAS) server, even if such a NAS server does not have a display chip. When executing a serial console, the initialization picture displaying method utilizes a chipset to actuate functions of a system management interface memory when a power-on self test (POST) program is executing an initialization process of an option ROM. The actuated system management interface memory works as a virtual display chip buffer. Therefore, option ROM manufacturers can still remotely display the initialization picture of an option ROM correctly, without requiring any changes when executing a serial console. After the initialization process is finished, the virtual display chip buffer is released, so as not to affect the operation of the server.

### BRIEF DESCRIPTIONS OF THE DRAWINGS

FIG. 1 is a flow chart of an initialization picture displaying method of the preferred embodiment according to the present invention.

### DETAILED DESCRIPTIONS OF PREFERRED EMBODIMENTS

The following illustrative embodiments are provided to illustrate the disclosure of the present invention. Other advantages and effects can be understood by those in the art after reading the disclosure of this specification. The present invention can also be performed or applied by other different embodiments. The details of the specification may be modified to suit different preferences or applications, and numerous modifications and variations can be devised without departing from the spirit of the present invention.

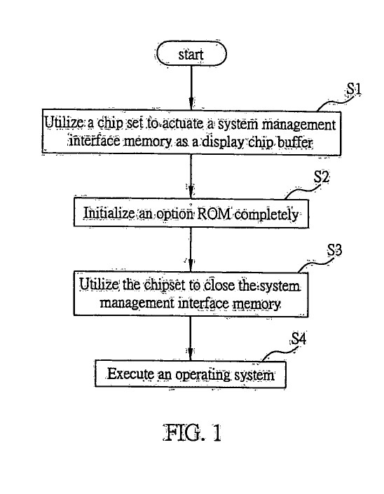

FIG. 1 is a flow chart of an initialization picture displaying method of the preferred embodiment according to the present invention. The initialization picture displaying method of the present invention is applicable to a network-attached storage (NAS) server having a main board without a display chip. Because a modern NAS server works as a server and is generally located in a server room, an administrator does not have to keep surveillance on the NAS server all the time. Therefore, the main board of the NAS server is not provided with a display chip. As such, the NAS server is unable to provide any display chip buffer for a serial console.

As a result, an erroneous initialization picture is remotely displayed if an option ROM accesses the display chip buffer directly. As to the problem of the prior art, the present invention provides an initialization picture displaying method by utilizing a basic input/output system (BIOS) to resolve the problem with a system management interface memory.

The initialization picture displaying method starts in step S1. In step S1, when the serial console is executed, a chipset is utilized to actuate functions of the system management interface memory when a power-on self test (POST) process is executing on the option ROM, so as to utilize the BIOS to provide a buffer working as a virtual display chip buffer. The initialization picture displaying method then proceeds to step S2.

In step S2, after the BIOS has provided the virtual display chip buffer, the option ROM is now allowed to access data of the virtual display chip buffer, and executes an initialization process and outputs an initialization picture to a remote user. The method then proceeds to step S3.

In step S3, as soon as the option ROM has executed the initialization process completely, the virtual display chip buffer provided by the system management interface memory is released for further usage. The method then proceeds to step S4.

In step S4, after the virtual display chip buffer provided by the system management interface memory is released, the NAS server can execute an operating system (OS) to execute normal functions.

The foregoing description of the detailed embodiment is illustrated to disclose the essential features and functions of the present invention and is not restrictive of the scope of the present invention. It should be understood by those in the art that numerous modifications and variations can be made according to the spirit and principles of the disclosure and yet still fall within the scope of the appended claims.

What is claimed is:

1. An initialization picture displaying method applicable to a server without a display chip, for remotely displaying working messages of the server, the initialization picture displaying method comprising the steps of:
(1) utilizing a chipset to reserve a region of a memory as a display chip buffer;
(2) initializing an option ROM completely;
(3) releasing the reserved region of the memory after the option ROM is initialized completely; and
(4) executing an operating system after the reserved region of the memory has been released.

2. The initialization picture displaying method of claim 1, wherein the server is a network-attached storage (NAS) server.

3. The initialization picture displaying method of claim 1, further comprising executing a serial console when executing step (1).

4. The initialization picture displaying method of claim 1, wherein the memory is a system management interface memory.

5. The initialization picture displaying method of claim 1, wherein the memory is provided by a basic input/output system (BIOS).
